(19) United States
(12) Patent Application Publication
(10) Pub. No.: US 2020/0117623 A1
(43) Pub. Date: Apr. 16, 2020

(54) Adaptive Interrupt Coalescing

(71) Applicant: PetaIO Inc., Santa Clara, CA (US)

(72) Inventors: Jinki Han, Yangpyeong-gun (KR); Jongman Yoon, San Jose, CA (US)

(21) Appl. No.: 16/156,839

(22) Filed: Oct. 10, 2018

(51) Int. Cl. G06F 13/24; G06F 3/06

(52) U.S. Cl. CPC G06F 13/24; G06F 3/0659; G06F 2213/2412; G06F 3/0673; G06F 3/061

(57) ABSTRACT

A storage device retrieves commands from a command queue of a host and monitors depth of the command queue. Commands are executed from the command queue and outcomes of the commands are written to a completion queue of the host. Interrupts for the completed commands are coalesced until an aggregation threshold or aggregation delay are met. Coalescing is disabled and interrupts generated upon completion of commands when depth of the command queue is below a threshold.

### BACKGROUND

### Field of the Invention

This invention relates to systems and methods for managing interrupts from a peripheral device to a host system.

### Background of the Invention

In a typical computing architecture, a storage device receives a command, executes the command, and sends an interrupt signal to a host with a completion queue entry to notify the host of completion of the command. In some approaches, interrupts are coalesced according to one or both of an aggregation time and an aggregation threshold. In the aggregation time approach, interrupts are aggregated for a threshold period of time before an interrupt is issued to the host system. In the aggregation threshold approach, interrupts are aggregated until a threshold number is reached before an interrupt is issued to the host system.

It would be an improvement in the art to improve the function of a storage or other peripheral device implementing interrupt coalescing.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a computing system suitable for implementing methods in accordance with embodiments of the invention;

FIG. 2 is a schematic block diagram of components of a storage system in accordance with the prior art;

FIG. 3 is a schematic block diagram of components for performing interrupt coalescing in accordance with the prior art;

FIGS. 4A and 4B are process flow diagrams illustrating interrupt coalescing in accordance with the prior art;

FIG. 5 is schematic block diagram of components for implementing an improved interrupt coalescing approach in accordance with an embodiment of the present invention; and

FIG. 6 is a process flow diagram of a method for performing interrupt coalescing in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

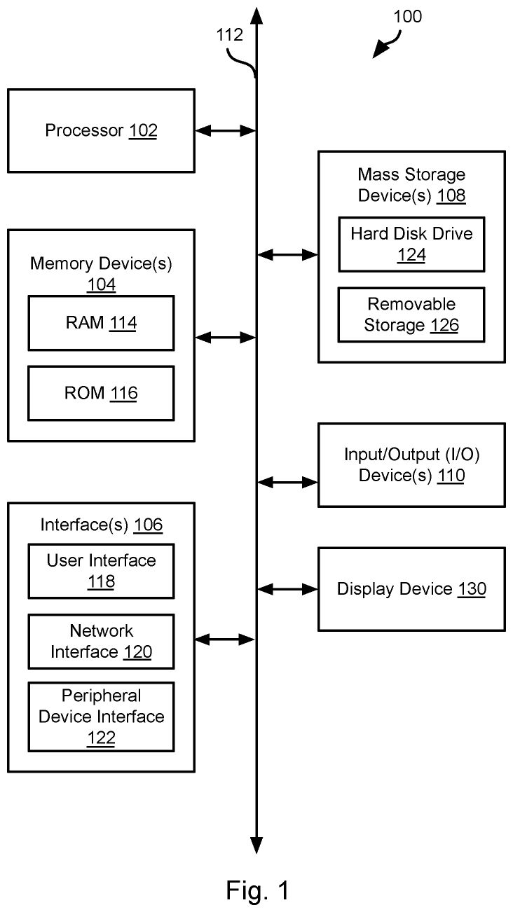

FIG. 1 is a block diagram illustrating an example computing device 100. Computing device 100 may be used to perform various procedures, such as those discussed herein. Computing device 100 can function as a server, a client, or any other computing entity. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). memory device(s) 104 may also include rewritable ROM, such as flash memory.

Mass storage device(s) 108 include various computer readable media, such as magnetic tapes, magnetic disks, optical disks, solid-state memory (e.g., flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

interface(s) 106 include various interfaces that allow computing device 100 to interact with other systems, devices, or computing environments. Example interface(s) 106 include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

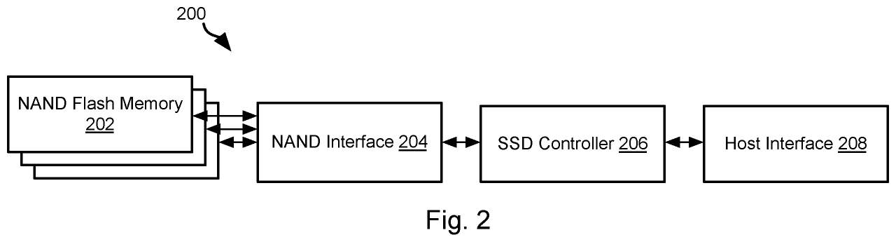

Referring to FIG. 2, a typically flash storage system 200 includes a solid state drive (SSD) that may include a plurality of NAND flash memory devices 202. One or more NAND devices 202 may interface with a NAND interface 204 that interacts with an SSD controller 206. The SSD controller 206 may receive read and write instructions from a host interface 208 implemented on or for a host device, such as a device including some or all of the attributes of the computing device 100. The host interface 208 may be a data bus, memory controller, or other components of an input/output system of a computing device, such as the computing device 100 of FIG. 1.

The methods described below may be performed by the host, e.g. the host interface 208 alone or in combination with the SSD controller 206. The methods described below may be used in a flash storage system 200 or any other type of non-volatile storage device. The methods described herein may be executed by any component in such a storage device or be performed completely or partially by a host processor coupled to the storage device.

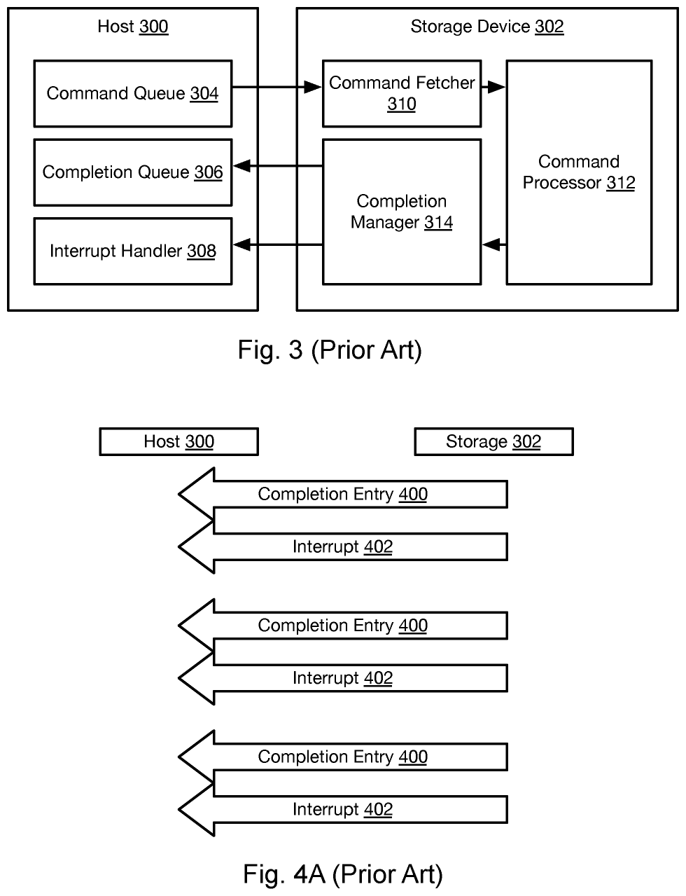

FIG. 3 illustrates a typical architecture in the prior art. In it, a host 300 is coupled to a storage device 302, such as a NAND flash SSD, other SSD device, or non-volatile storage device such as a hard disk drive. The functions ascribed to the host 300 may be performed by the host interface 208 or a processor 102 of the host 300. The functions ascribed to the storage device 302 may be performed by the SSD controller 206, NAND interface 204, or some other component of the storage device 302.

The host 300 may implement a command queue 304, a completion queue 306, and an interrupt handler 308. The command queue 304 stores commands that are fetched and executed by the storage device 302. The commands may be executed using one or both of the Flash Translation Layer (FTL) and Flash Interface Layer (FIL) of the storage device 302 The completion queue 306 stores outcomes from execution of the commands by the storage device 302. In some embodiments, multiple command queues 304 (also referred to as submission queues 304 in some contexts) may be mapped by the host 300 to the same completion queue 306. The command queue 304 and completion queue 306 may be implemented in hardware or firmware.

The interrupt handler 308 receives interrupts from the storage device 302 and performs functions corresponding to the interrupt. For example, the interrupt handler 308 may define a plurality of interrupts or interrupts vector and perform a function corresponding to each interrupt when the each interrupt is set by the storage device 302. For example, where a command is a read operation, the completion queue 306 may include the data read by the storage device in response to the read operation. Accordingly, the interrupt handler 308 may respond to an interrupt from the storage device 302 by reading the data from the completion queue 306 and returning it to a process that invoked the read operation. The manner in which the interrupt handler 308 implements and processes interrupts may be according to any approach for implementing known in the art.

The storage device 302 may include a command fetcher 310 that retrieves commands from the command queue 304 and invokes execution of the commands by a command processor 312. For example, the command processor 312 may read and write data from a storage medium in response to read and write commands, respectively and return a result of the commands to a completion manager 314. The completion manager places the result of each command (“the completion entry”) in the completion queue 306 and further generates an interrupt to the interrupt handler 308. The interrupt handler 308 will then read the completion entries and remove them from the completion queue 306.

The storage device 302 may be embodied as a Non Volatile Memory Express (NVMe) device and the host 300 may define an interface according to the NVMe specification for interacting with an NVMe device.

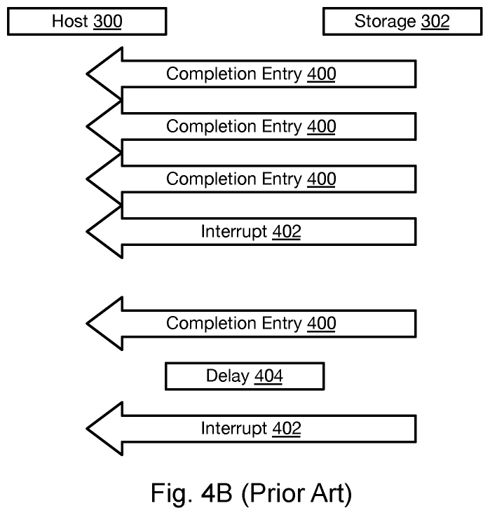

FIGS. 4A and 4B illustrate conventional approaches to generation of interrupts by a completion manager 314. In the first approach, for each completion entry 400 added to the completion queue 306 by the completion manager 314, the completion manager 314 also generates an interrupt 402 corresponding to that completion entry 400. This approach provides low latency inasmuch as the host is alerted to the availability of the result of a command after it is placed in the completion queue 306. However, processing of interrupts requires processing cycles of the host 300 and therefore this approach increases loading of the host 300.

The approach of FIG. 4B reduces the load on the host 300 by performing coalescing of interrupts. For example, an interrupt 402 may be generated only after a threshold number of completion entries (“the aggregation threshold”) has been received since that last interrupt was generated. Alternatively, an interrupt 402 is generated for a completion entry 400 only after waiting a delay 404 (“the aggregation delay”) following the last generation of an interrupt. In some instances, both are used such that if either of the aggregation delay and the aggregation threshold are met an interrupt 402 is generated.

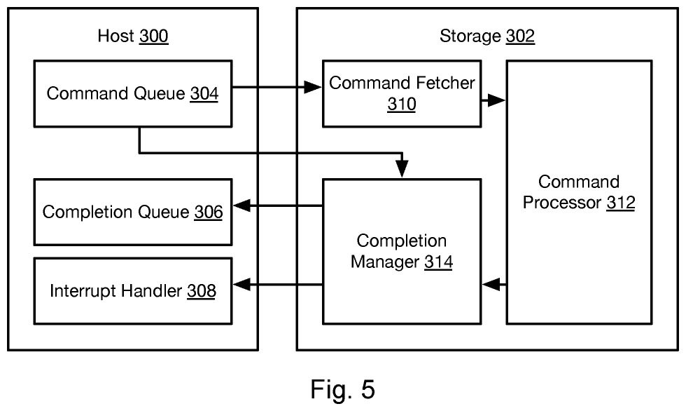

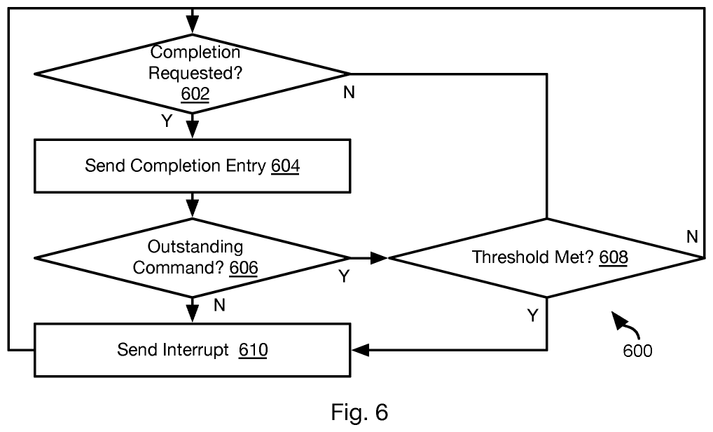

FIG. 5 illustrates an improved architecture for implementing interrupt coalescing. The elements of the architecture of FIG. 5 may function in the same manner as the like-numbered elements of FIG. 3 except as described below. In particular, the completion manager 314 may be modified relative to the approach of FIG. 3 to implement the approach of FIG. 5 and the method of FIG. 6.

In the approach of FIG. 5, the completion manager 314 further receives a state of the command queue 304 from the host 300. In particular, the completion manager 314 may receive a depth of the command queue that is the number of commands in the queue 304 that either have not been fetched by the command fetcher 310 or have not been processed by the command processor. Alternatively, the completion manager 314 may receive an index of a head and the index of a tail of the command queue 304 from which the completion manager calculates a number of commands in the command queue. Note that one or more values used to determine the depth of the command queue 304 may be provided by the host 300 to the command fetcher 310 to enable fetching of commands from the queue 304.

FIG. 6 illustrates a method 600 that may be executed using the architecture of FIG. 5. For example, the method 600 may be executed by a storage device 302, such as the completion manager 314.

The method 600 may include evaluating whether a completion is requested by the command processor 312 for a command. In response, the completion manager 314 sends 604 a completion entry including a result of the command as received from the command processor 312 to the completion queue 306 of the host 300. The completion manager 314 may further evaluate 606 whether there are commands outstanding in the command queue 304. Step 606 may include evaluating whether there are any commands in the command queue 304 or whether the number of commands in the command queue 304 meets a depth threshold. If the result of step 606 is negative (no commands in the command queue 304 or the threshold condition is not met), then an interrupt is sent 610 to the interrupt handler 308. As a result of steps 606 and 610, coalescing of completions is disabled and consideration of the completion queue 306 with respect to an aggregation threshold or aggregation time is disabled. This will therefore reduce latency in cases where the command queue depth is low.

For example, if the command queue depth is lower than the aggregation threshold, it is unlikely that the aggregation threshold will be met and therefore generation of an interrupt will be delayed until the aggregation delay is met. Accordingly, the depth threshold may be selected to be a value that is smaller than the aggregation threshold. Likewise, the storage device may have the ability to process a certain number of commands per unit time (“throughput”). Accordingly, the depth threshold may be selected such that the depth threshold divided by the throughput is less than the aggregation delay.

In instances where multiple command queues 304 are mapped to the same completion queue 306, step 606 may include evaluating all of these queues. For example, where a single command is sufficient to meet the condition of step 606, a command in any of the command queues 304 mapped to the completion queue will be sufficient to meet the condition of step 606. Where a threshold number of commands is required, when the aggregate number of commands in the command queues meets this threshold number, the condition of step 606 may be deemed to be met.

If the result of step 606 is positive (a command in the command queue 304 or the threshold condition is met), then step 608 may be executed. Step 608 may include evaluating 608 whether a threshold is met 608 by the number of completions in the completion queue 306 that have not been read and removed by the interrupt handler. In particular, step 608 may include evaluating the number of completions in the completion queue 306 with respect to one or both of an aggregation threshold and an aggregation time. In particular, if the number of completions in the completion queue 306 meets the aggregation threshold, the result of step 608 if positive. If the oldest completion in the completion queue 306 is older than the aggregation time, then the result of step 608 is positive. In some approaches, the completion queue 306 is only evaluated with respect to one of the aggregation threshold and the aggregation delay.

If the result of step 608 is positive, then an interrupt is sent 610 to the host. If the result of step 608 is negative, processing may continue at step 602. In particular, an interrupt is not generated until the result of step 606 or step 608 is positive. Note that where no completion request is received 602 during an iteration of the method 600 but the result of step 608 is positive, then an interrupt is sent 610.

Note that a single storage device 302 may have multiple corresponding interrupt vectors implemented by the host 300. In some embodiments, each interrupt vector has its own corresponding command queue 304 and completion queue 306. Accordingly, completion entries for commands corresponding to a particular interrupt vector may be placed in the completion queue 306 for that interrupt vector. Accordingly, the method 600 may be executed for each interrupt vector based on the state of the command queue 304 and completion queue 306 of that interrupt vector.

The advantage of the approach of FIGS. 5 and 6 is that latency is improved in instances where aggregation is not effective to reduce host loading. In particular, by evaluating the state of the command queue 304 the completion manager 314 is able to consider a future state of the completion queue 306. The completion manager 314 may therefore send an interrupt immediately rather than wait for aggregation thresholds to be met where the command queue 304 indicates that the number of outstanding commands is unlikely to result in meeting the aggregation threshold. Note also that the processing of the method 600 may be performed completely on the storage device 302 and therefore does not increase the loading on the host 300. Likewise, no modification of the host 300 is required. Accordingly, a storage device 300 implementing the approach of FIGS. 5 and 6 may be used with any host 300 implementing an interface according to the NVMe specification when the storage device 300 is an NVMe device modified according to FIGS. 5 and 6.

In prior systems, the aggregation delay and aggregation threshold are global to all interrupt vectors. Using the approach described above, the interrupt coalescing for each interrupt vector is managed according to the command queue 304 and completion queue 306 for that interrupt vector thereby enabling more fine control of the coalescing for each interrupt vector.

The present invention may be embodied in other specific forms without departing from its spirit or essential characteristics. The described embodiments are to be considered in all respects only as illustrative, and not restrictive. In particular, although the methods are described with respect to a NAND flash SSD, other SSD devices or non-volatile storage devices such as hard disk drives may also benefit from the methods disclosed herein. The scope of the invention is, therefore, indicated by the appended claims, rather than by the foregoing description. All changes which come within the meaning and range of equivalency of the claims are to be embraced within their scope.

What is claimed is:

1. A method comprising:
providing a host having a command queue and a completion queue;
providing a peripheral device;
(a) executing, by one of the peripheral device and the host, commands from the command queue and placing outcomes of the commands in the completion queue;
(b) generating, by the one of the peripheral device and the host, an interrupt for each command from the command queue upon completion without coalescing when a depth of the command queue is below a threshold; and
(c) generating, by the one of the peripheral device and the host, the interrupt after coalescing completions of multiple commands when the depth of the command queue is above the threshold.

2. The method of claim 1, wherein the one of the peripheral device and the host is the peripheral device.

3. The method of claim 1, wherein generating the interrupt after coalescing completions of multiple commands comprises:
generating the interrupt when a number of completions of commands from the command queue since a previous generation of the interrupt exceeds a threshold number.

4. The method of claim 1, wherein generating the interrupt after coalescing completions of multiple commands comprises:
generating the interrupt when a delay from a time of completion of a last-completed command of the commands from the command queue exceeds a threshold time.

5. The method of claim 1, wherein generating the interrupt after coalescing completions of multiple commands comprises:
generating the interrupt when a number of completions of commands from the command queue since a previous generation of the interrupt exceeds a threshold number; and
generating the interrupt when a delay from a time of completion of a last-completed command of the commands from the command queue exceeds a threshold time.

6. The method of claim 5, wherein generating the interrupt for each command without coalescing comprises, generating an interrupt for the each command upon placing of the outcome of the each command in the command queue without regard to either of:
the number of completions of commands from the command queue since the previous generation of the interrupt; and
the delay from the time of completion of the last-completed command of the commands from the command queue exceeds a threshold time.

7. The method of claim 1, wherein the peripheral device is a storage device and the commands are read and write commands.

8. The method of claim 1, wherein the peripheral device is a NAND storage device.

9. The method of claim 8, wherein the peripheral device is a Non-Volatile Memory Express (NVMe) device.

10. The method of claim 1, wherein the interrupt is one of a plurality of interrupts;
wherein the completion queue is one of a plurality of completion queues, each completion queue corresponding to one of the plurality of interrupts; and
wherein the method further comprises performing (a) through (c) for each interrupt of the plurality of interrupts and the completion queue corresponding to the each interrupt.

11. An apparatus comprising:
a peripheral device having a controller programmed to:
(a) execute commands from a command queue of a host device coupled to the peripheral device and place outcomes of the commands in a completion queue of the host device;
(b) generate an interrupt to the host device for each command from the command queue upon completion without coalescing when a depth of the command queue does not meet a threshold condition; and
(c) generate the interrupt after coalescing completions of multiple commands when the depth of the command queue meets the threshold condition.

12. The apparatus of claim 11, further comprising the peripheral device.

13. The apparatus of claim 11, wherein the controller is programmed to generate the interrupt after coalescing completions of multiple commands by:
generating the interrupt when a number of completions of commands from the command queue since a previous generation of the interrupt exceeds a threshold number.

14. The apparatus of claim 11, wherein the controller is programmed to generate the interrupt after coalescing completions of multiple commands by:
generating the interrupt when a delay from a time of completion of a last-completed command of the commands from the command queue exceeds a threshold time.

15. The apparatus of claim 11, wherein the controller is programmed to generate the interrupt after coalescing completions of multiple commands by:
generating the interrupt when a number of completions of commands from the command queue since a previous generation of the interrupt exceeds a threshold number; and
generating the interrupt when a delay from a time of completion of a last-completed command of the commands from the command queue exceeds a threshold time.

16. The apparatus of claim 15, the controller is programmed to generate the interrupt for each command without coalescing by, generating an interrupt for the each command upon placing of the outcome of the each command in the command queue without regard to either of:
the number of completions of commands from the command queue since the previous generation of the interrupt; and
the delay from the time of completion of the last-completed command of the commands from the command queue exceeds a threshold time.

17. The apparatus of claim 11, wherein the peripheral device is a storage device and the commands are read and write commands.

18. The apparatus of claim 11, wherein the peripheral device is a NAND storage device.

19. The apparatus of claim 11, wherein the peripheral device is a Non-Volatile Memory Express (NVMe) device.

20. The apparatus of claim 11, wherein the interrupt one of a plurality of interrupts;
wherein the completion queue is one of a plurality of completion queues, each completion queue corresponding to one of the plurality of interrupts;
wherein the controller is further programmed to perform (a) through (c) for each interrupt of the plurality of interrupts and the completion queue corresponding to the each interrupt.
